(19) United States
(12) Patent Application Publication
(10) Pub. No.: US 2017/0157811 A1
(43) Pub. Date: Jun. 8, 2017

(54) IMPRINT APPARATUS, IMPRINT METHOD, AND MANUFACTURING METHOD OF PRODUCT

(71) Applicant: CANON KABUSHIKI KAISHA, Tokyo (JP)

(72) Inventor: Yuichi Fujita, Utsunomiya-shi (JP)

(21) Appl. No.: 15/362,641

(22) Filed: Nov. 28, 2016

(30) Foreign Application Priority Data
Dec. 4, 2015 (JP) 2015-237870

(51) Int. Cl. B29C 43/02; B29C 43/58

(52) U.S. Cl. CPC B29C 43/021; B29C 43/58

(57) ABSTRACT

An imprint apparatus according to the present invention is configured to form a pattern of an imprint material on a substrate with a mold, and includes a mold holding unit configured to hold the mold, a substrate holding unit configured to hold the substrate, a driving mechanism configured to change relative position of the mold holding unit and the substrate holding unit, and a control unit configured to control, when the relative position of the mold holding unit and the substrate holding unit is changed while the mold is in contact with the imprint material on the substrate, the driving mechanism in such a manner that driving force to be generated due to viscoelasticity of the imprint material becomes smaller.

### BACKGROUND OF THE INVENTION

Field of the Invention

The present disclosure generally relates to an imprint apparatus, an imprint method, and a manufacturing method of a product.

Description of the Related Art

An increased demand for smaller semiconductor devices and Micro Electro Mechanical Systems (MEMS) attracts attention to an imprint technique for forming a minute pattern on an imprint material supplied on a substrate with a mold, in addition to a conventional photolithography technique. One example of the imprint technique is a photo-curing method.

In an imprint apparatus employing the photo-curing method, the following processing is executed to form a pattern of the imprint material on the substrate. First, the imprint material is supplied (coated) on a shot area (imprint area) on the substrate. Then, the imprint material supplied on the substrate is brought into contact with a mold. The imprint material is then irradiated with light (ultraviolet light) to be cured, and the mold is separated from the imprint material that has been cured.

Bubbles may be trapped between the mold and the imprint material on the substrate in contact with each other (a recess on the pattern formed on the mold). The imprint material having cured with trapped bubbles may cause deficiency in the pattern of the imprint material to be generated on the substrate.

Japanese Patent Application Laid-Open No. 2012-099790 discusses an imprint method with which the deficiency in the pattern can be prevented. More specifically, the mold is brought into contact with the imprint material in a state that the mold is warped to protrude toward the substrate, and then the mold is gradually flattened. In this manner, contact between the imprint material and the entire surface of the pattern formed on the mold can be achieved. More specifically, in the imprint method discussed in Japanese Patent Application Laid-Open No. 2012-099790, the mold is brought into contact with the imprint material while being deformed, and a contact area between the mold and the imprint material gradually increases to finally expand to an area on the mold where the pattern is formed (pattern formation area). The contact of the mold deformed in the protruding shape with the imprint material from the center of the pattern formation area can prevent the bubbles from being trapped between the mold and the imprint material.

However, the mold and the imprint material may be in contact with each other with the center of the contact area (centroid) deviating from the center of the pattern formation area, depending on the warp state of the mold and a position on the substrate where the pattern is formed. In this context, Japanese Patent Application Laid-Open No. 2009-200345 discusses control performed so that the position (contact area) where the mold first is brought into contact with the imprint material is aligned with the center of the imprint area on the substrate. More specifically, the mold is brought into contact with the imprint material while being inclined relative to the substrate.

After the mold has contacted the imprint material while being inclined with respect to the substrate, the mold needs to be controlled so as to become parallel to the substrate. When the mold in contact with the imprint material is moved relative to the substrate, force acts on the mold and the substrate due to the viscoelasticity of the imprint material. The pattern formed on the mold is deformed by such force to have a different shape relative to the shot area of the substrate.

The force generated due to the viscoelasticity of the imprint material hinders smooth operation of a driving mechanism performed when the mold and the substrate are positioned, leading to lower positioning accuracy between a mold side pattern and a substrate side pattern.

### SUMMARY OF THE INVENTION

An imprint apparatus according to the present disclosure is configured to form a pattern of an imprint material on a substrate with a mold, and includes a mold holding unit configured to hold the mold, a substrate holding unit configured to hold the substrate, a driving mechanism configured to change relative position of the mold holding unit and the substrate holding unit, and a control unit configured to control, when the relative position of the mold holding unit and the substrate holding unit is changed while the mold is in contact with the imprint material on the substrate, the driving mechanism in such a manner that driving force to be generated due to viscoelasticity of the imprint material becomes smaller.

Further features of the present disclosure will become apparent from the following description of exemplary embodiments with reference to the attached drawings.

### BRIEF DESCRIPTION OF THE DRAWINGS

FIG. 1 is a diagram illustrating an imprint apparatus according to an exemplary embodiment.

FIG. 2 is a flowchart illustrating a sequence of imprint processing according to an exemplary embodiment.

FIG. 3 is a diagram illustrating a state of an imprint apparatus according to a first exemplary embodiment.

FIG. 4 is a diagram illustrating an imprint position on a substrate.

FIG. 5 is a diagram illustrating a positional relationship between a mold and a substrate according to a second exemplary embodiment.

FIGS. 6A and 6B are diagrams each illustrating a state of an imprint apparatus according to the second exemplary embodiment.

### DESCRIPTION OF THE EMBODIMENTS

Exemplary embodiments of the disclosure are described in detail below with reference to the attached drawings. In the drawings, the same components are denoted with the same reference numerals, and redundant descriptions will be omitted.

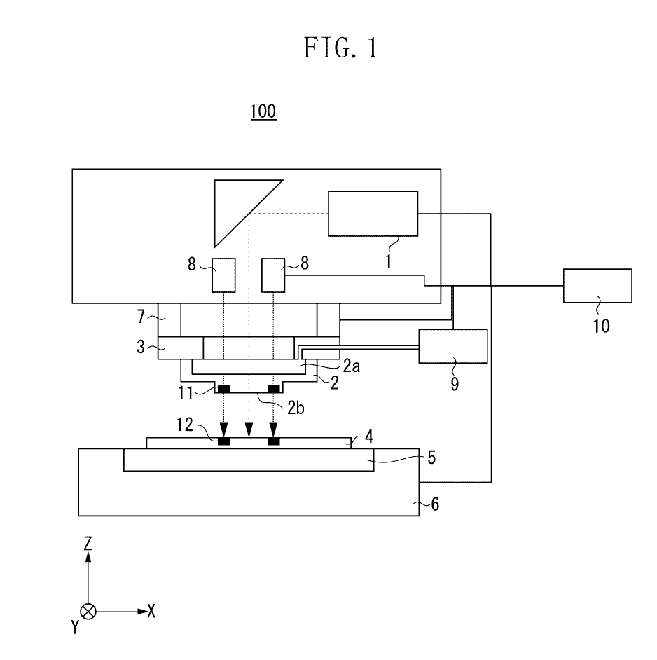

An imprint apparatus 100 according to an exemplary embodiment of the disclosure is described. FIG. 1 is a diagram illustrating a configuration of the imprint apparatus 100. Axes illustrated in the figure are defined based on an XY plane as a plane on which a mold 2 (substrate 4) is disposed and a Z direction as a direction orthogonal to the XY plane.

In the imprint apparatus 100, the mold 2 comes into contact with an imprint material supplied on the substrate 4. In this state, the imprint material is provided with energy for curing, so that a pattern of the imprint material is formed on the substrate 4. The imprint material to be used includes a curable composition (also referred to as uncured resin) that is cured upon receiving the energy for curing. The energy for curing includes electromagnetic waves, radiation, and heat. For example, the electromagnetic waves are light such as infrared light, visible light, and ultraviolet light with a wavelength selected within a range from 10 nm inclusive to 1 mm inclusive. The imprint apparatus 100 described herein employs a photo-curing method in which the imprint material is irradiated with light (ultraviolet light) to be cured. Alternatively, a thermal-curing method in which the imprint material is provided with heat to be cured may be employed.

The imprint apparatus 100 includes a light emitting unit 1, a mold holding mechanism 3 that holds the mold 2, a substrate holding mechanism 5 that holds the substrate 4, a substrate stage 6 (substrate driving mechanism), a mold driving mechanism 7, detection units 8, and a control unit 10. The imprint apparatus 100 further includes components such as a substrate conveyance mechanism, a mold conveyance mechanism, and a coating mechanism that supplies the imprint material onto the substrate 4 (not illustrated).

The light emitting unit 1 emits ultraviolet light toward the mold 2 in curing the imprint material. The ultraviolet light travels through the mold 2, so that the light emitting unit 1 can irradiate the imprint material with ultraviolet light through the mold 2. An axis of the ultraviolet light emitted toward the mold 2 is parallel to the Z direction. The light emitting unit 1 includes a light source and an optical element with which the ultraviolet light emitted from the light source is adjusted to be appropriate light.

The mold 2 has a rectangular outer circumference shape, and includes a predetermined three-dimensional formed pattern 2b (a recess-protrusion pattern, such as a circuit pattern, to be transferred onto the substrate 4). The pattern 2b is formed on a surface (pattern surface) facing the substrate 4. The mold 2 is made of a material such as quartz through which the ultraviolet light can transmit. The mold 2 may have a shape with a cavity space 2a (recess) of a certain depth formed thereon.

The mold holding mechanism 3 is a mold holding unit that holds (fixes) the mold 2 with vacuum suction force or electrostatic force. The mold holding unit includes a mold driving mechanism 7 (driving mechanism) that holds and moves the mold holding mechanism 3. The mold driving mechanism 7 can move the mold 2 held by the mold holding mechanism 3 in the Z direction. The mold driving mechanism 7 may include a rotation mechanism that inclines the mold 2 towards the substrate 4 or rotates the mold 2 about the Z axis. The mold driving mechanism 7 may further include a driving mechanism that moves the mold 2 in X and Y directions to adjust relative position of the mold 2 and the substrate 4 in an in-plane direction. The mold holding mechanism 3 and the mold driving mechanism 7 each have a center portion (inner side) having an opening through which the ultraviolet light from the light emitting unit 1 is emitted toward the imprint material on the substrate 4.

The mold holding mechanism 3 further includes a light transmissive member (for example, a glass plate). The mold 2 and the transmissive member define the cavity space 2a as an enclosed space. A pressure adjustment mechanism 9 (mold deforming mechanism) controls pressure in the cavity space 2a. For example, when the mold 2 comes into contact with the imprint material, the pressure in the cavity space 2a is increased by the pressure adjustment mechanism 9 to be higher than the outside pressure so that the pattern 2b on the mold 2 is warped to protrude toward the substrate 4.

The substrate holding mechanism 5 is a substrate holding unit that holds (fixes) the substrate 4, conveyed thereto by the substrate conveyance mechanism, with vacuum suction force or electrostatic force. The substrate holding unit includes a substrate stage 6 that is driven while holding the substrate holding mechanism 5. The substrate stage 6 can move the substrate 4 held by the substrate holding mechanism 5 on the XY plane (in the in-pane direction of the substrate 4). The substrate stage 6 may perform the control with a degree of freedom not only in the X and Y directions. More specifically, the substrate stage 6 may include a rotation mechanism that rotates the substrate 4 (ωx, ωy, and ωz about the axes) and a driving mechanism that moves the substrate 4 in the Z direction. The degree of freedom in each direction may be measured with a laser interferometer, an electrostatic capacity sensor, an optical sensor, a laser displacement meter, and the like.

The detection units 8 detect mold alignment marks 11 formed on the mold 2 and substrate alignment marks 12 formed on the substrate 4. The detection units 8 may be provided to the mold holding unit 3, and directly detect the alignment marks 11 and 12 formed on the mold 2 and the substrate 4, or may detect the alignment marks 11 and 12 with an optical member such as a lens provided between the alignment marks 11 and 12 and the detection units 8.

The control unit 10 measures the positional deviation between the alignment marks 11 and 12 in each of X and Y axis directions, from the result of detecting the alignment mark with the detection units 8. Thus, relative position of (positional deviation between) the mold 2 and the substrate 4 in the in-plane direction (the X direction and the Y direction) is obtained. The control unit 10 moves the substrate stage 6 (adjusts the position of the substrate stage 6) based on the obtained relative position of the mold 2 and the substrate 4 so that the position of the mold 2 and the position of the substrate 4 are aligned with each other.

The relative position of the mold 2 and the substrate 4 may be calculated by using a result of measuring the relative position of the mold alignment mark 11 and the relative position of the substrate alignment mark 12 with respect to a reference mark formed on the substrate stage 6. The substrate alignment mark 12 may be provided to each shot area of the substrate 4 so that the positioning is performed for each shot area. Alternatively, positions of the substrate alignment marks 12 formed on at least two or more shot areas on the substrate 4 may be measured. Still alternatively, statistic processing may be executed on a result of measuring an alignment mark formed on a sample shot area. Yet still alternatively, an alignment system may be employed that uses a coordinate system for correction based on deviation in planer and rotational direction of the substrate and magnification error.

The control unit 10 can obtain the shape of the pattern 2b based on the result of detecting the mold alignment marks 11 formed on the mold 2. The control unit 10 can obtain a pattern shape (shot area shape) formed on the substrate 4 based on the result of detecting the substrate alignment marks 12 formed on the substrate 4. In this manner, the detection unit 8 also functions as a device that measures a matching state between the shape of the shot area on the substrate 4 as a target of the imprint processing and the pattern 2b formed on the mold 2.

As described above, the substrate stage 6 serves as the substrate driving mechanism that moves the substrate 4 to a desired position, and is driven in such a manner that the shot area on the substrate 4 is positioned relative to the mold 2 (pattern 2b). Accordingly, the substrate stage 6 is required to achieve positioning accuracy (alignment accuracy), required for a lithography device, that is, on the order of a nanometer. The driving force corresponding to viscoelasticity of the imprint material is required for changing relative position of the substrate 4 and the mold 2 that is in contact with the imprint material, in a direction along the XY plane. More specifically, the driving force is required for the substrate stage 6 (substrate driving mechanism) when the positioning is performed in a state where the mold 2 and the imprint material are in contact with each other. Magnitude of the driving force required for the substrate stage 6 to perform the positioning increases as the viscoelasticity of the imprint material increases. The case where the substrate stage 6 is driven for the positioning is described above. Alternatively, the mold driving mechanism 7 (mold holding mechanism 3) may be driven for the positioning. In this case, the magnitude of the driving force for the mold driving mechanism 7 to perform the positioning increases as the viscoelasticity of the imprint material increases. Thus, the substrate stage is provided with a pressure sensor and the like for measuring force (shearing force) generated due to the viscoelasticity of the imprint material. Alternatively, the force generated due to the viscoelasticity of the imprint material is obtained based on the difference between an instructed value of the driving force for the substrate stage 6 and an actual driven amount.

An imprint material with a larger viscoelasticity requires larger driving force for driving the substrate stage 6 for the positioning. There is a correlation between the magnitude of the driving force for driving the substrate stage 6 and a positioning error, indicating that the driving force needs to be small for accurate positioning.

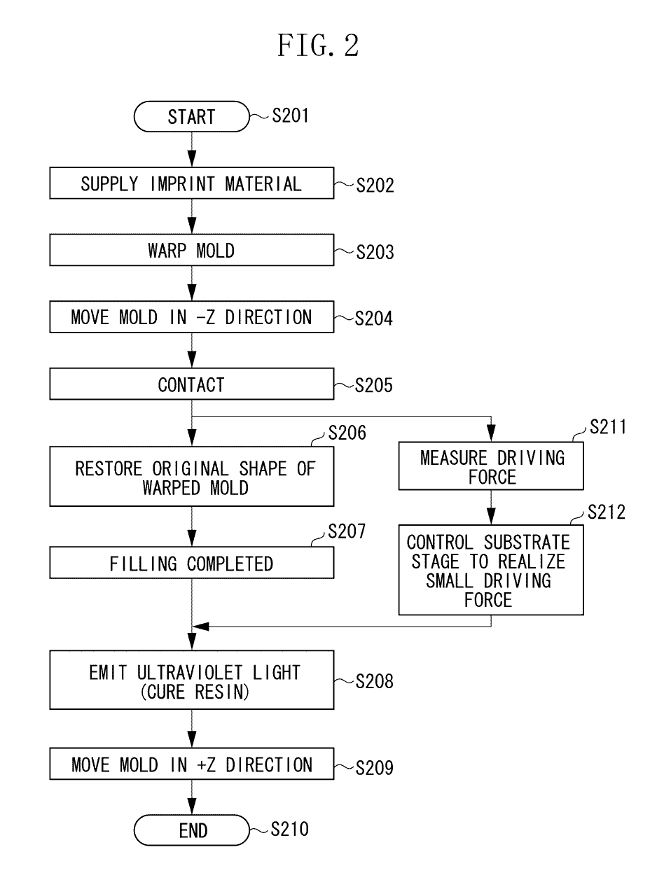

Next, a sequence of imprint processing according to the disclosure is described with reference to FIG. 2. FIG. 2 is a flowchart illustrating the sequence of the imprint processing.

In step S201, the control unit 10 starts the imprint processing. The mold 2 is conveyed by the mold conveyance mechanism (not illustrated) into the imprint apparatus 100 to be held by the mold holding mechanism 3. The substrate 4 is conveyed by the substrate conveyance mechanism (not illustrated) into the imprint apparatus 100 to be held by the substrate holding mechanism 5.

In step S202, the coating mechanism (not illustrated) supplies the imprint material onto the shot area on the substrate 4 (coating). The substrate stage 6 moves in such a manner that the shot area on which the imprint material is supplied is disposed below the pattern 2b of the mold 2.

In step S203, the pressure adjustment mechanism 9 increases the pressure in the cavity space 2a to be higher than the outside pressure, so that the mold 2 is deformed in such a manner that the pattern 2b of the mold 2 is warped to protrude toward the substrate 4. The deformation of the mold 2 in step S203 may be performed in parallel with supplying of the imprint material onto the substrate 4 in step S202.

In step S204, the control unit 10 reduces the distance between the mold 2 and the substrate 4 so that the pattern 2b of the mold 2 comes into contact with the imprint material on the substrate 4. More specifically, the distance between the mold 2 and the substrate 4 is reduced by moving the mold driving mechanism 7 toward the substrate 4 (in a −Z direction). Then, the mold driving mechanism 7 moves the mold holding mechanism 3 (mold 2) toward the substrate 4 (in a −Z direction) so that the pattern 2b of the mold 2 comes into contact with the imprint material on the substrate 4. In step S205, the pattern 2b of the mold 2 and the imprint material on the substrate 4 come into contact with each other.

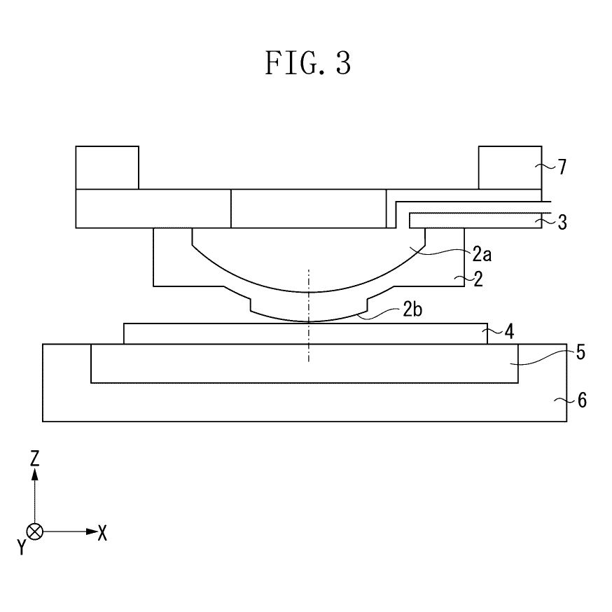

FIG. 3 is a diagram illustrating a state where the pattern 2b of the mold 2 is in contact with the imprint material on the substrate 4 in the imprint processing according to the first exemplary embodiment. The pressure adjustment mechanism 9 increases the pressure in the cavity space 2a to be higher than the outer pressure, so that the pattern 2b of the mold 2 is warped to protrude toward the substrate 4. In this manner, contact between the pattern 2b of the mold 2 and the imprint material on the substrate can start from the center portion of the pattern 2b, reducing bubbles trapped between the pattern 2b of the mold 2 and the imprint material. With the mold 2 being warped, the recess of the pattern 2b can be filled with the imprint material within a short period of time after the mold 2 comes into contact with the imprint material.

In step S206, the pressure adjustment mechanism 9 reduces the pressure in the cavity space 2a to restore the original planer shape of the pattern 2b of the mold 2 that has been warped to protrude (restoring original shape). More specifically, the original shape of the mold 2 can be restored by gradually reducing the pressure in the cavity space 2a as the contact area increases after the pattern 2b of the mold 2 comes into contact with the imprint material on the substrate 4. Alternatively, the pressure in the cavity space 2a may be reduced after the contact area has been increased by pressing the mold 2 with the cavity space 2a in the high pressure state against the substrate 4.

In step S207, the mold driving mechanism 7 ends with the moving of the mold 2 in the −Z direction, and the filling of the imprint material in the recess of the pattern 2b of the mold 2 is completed.

In step S208, the light emitting unit 1 emits ultraviolet light toward the imprint material to cure the imprint material on the substrate 4.

In step S209, the control unit 10 increases the distance between the mold 2 and the substrate 4 so that the pattern 2b of the mold 2 is separated from the imprint material on the substrate 4 that has been cured. More specifically, the mold driving mechanism 7 is moved in the +Z direction so that the pattern 2b of the mold 2 is pulled away from the imprint material on the substrate 4 that has been cured (separating). After the mold 2 is pulled away from the imprint material that has been cured, in a case where there is another shot area for which the pattern is to be formed, the process returns to step S202, and the imprint material is supplied to the shot area for which the pattern is to be formed. In this manner, the pattern of the imprint material can be formed on a plurality of shot areas on the substrate 4 through a sequence of imprint operations repeated for each shot area.

In step S210, the control unit 10 terminates the imprint processing. More specifically, when there is no next shot area for which the pattern is to be formed after the pattern is formed on the shot area on the substrate 4, the substrate conveyance mechanism (not illustrated) conveys the substrate 4 out of the imprint apparatus 100 from the substrate holding mechanism 5. When the mold 2 is replaced, the mold conveyance mechanism (not illustrated) conveys the mold 2 out of the imprint apparatus 100 from the mold holding mechanism 3.

In the imprint processing, the relative position of the mold 2 and the substrate 4 is obtained by detecting the mold alignment marks 11 formed on the mold 2 and the substrate alignment marks 12 formed on the substrate 4 with the detection units 8. The positioning on the XY plane (in the plane of the substrate 4) is realized by the substrate stage 6 being moved based on information about the obtained relative position. Larger driving force used for the positioning involves higher risk of deformation of the pattern 2b due to excessive force acting on the pattern 2b of the mold 2 or the degradation of the positioning accuracy.

To that end, in step S211, in the imprint apparatus 100 according to the disclosure, the control unit 10 measures the driving force (or shearing force) in the XY plane generated for the substrate stage 6. More specifically, the driving force (or shearing force) generated on the substrate stage 6 in the XY plane is measured in a period starting when the pattern 2b of the mold 2 comes into contact with the imprint material on the substrate 4 and ending when the pattern 2b is separated from the imprint material that has been cured.

Then, in step S212, the control unit 10 controls the substrate stage 6 by calculating speed and position realizing small driving force in the XY plane based on a value of the calculated driving force for the substrate stage 6.

Controlling the substrate stage 6 to realize the small driving force may leads to deviation in positioning between the mold 2 and the substrate 4 which is realized by detecting the mold and the substrate alignment marks 11 and 12 with the detection units 8. Thus, the substrate stage 6 may be offset by a movement amount δS for realizing the small driving force obtained in advance, before the pattern 2b of the mold 2 comes into contact with the imprint material on the substrate 4. More specifically, the substrate stage 6 may be moved by the movement amount δS in a direction opposite to that for realizing the small driving force. In this manner, the positioning between the mold 2 and the substrate 4 can be facilitated even in a case where the substrate stage 6 is moved to realize the small driving force after the pattern 2 and the imprint material come into contact with each other.

The movement amount δS of the substrate stage 6 obtained in advance may be determined based on a material of an adhesion layer supplied between the substrate 4 and the imprint material, a material of the mold 2, and a layout of the pattern formed on the mold 2. The movement amount δS of the substrate stage 6 may also be determined based on the viscosity, the supplied amount, and the coating pattern of the imprint material. In such a manner, the movement amount δS of the substrate stage 6 may be obtained based on aspects that may affect the driving force required for changing the relative position of the mold 2 and the substrate 4.

In the present exemplary embodiment, the substrate stage 6 is moved to realize the small driving force. Alternatively, the mold driving mechanism 7 that moves the mold 2 may be moved in the XY direction because changing the relative position of the mold 2 and the substrate 4 in the X and Y directions can reduced the driving force. Furthermore, the substrate stage 6 and the mold driving mechanism 7 may be moved concurrently or one by one.

It is desirable that the measurement of the driving force (step S211) and the controlling of the substrate stage 6 (step S212) are performed constantly while the imprint processing is in process, but may also be intermittently performed. The driving of the mold driving mechanism 7 in the Z direction may be temporarily stopped while the substrate stage 6 is moving.

With the relative position of the mold 2 and the substrate 4 being changed as described above, the driving force can be prevented from increasing, so that degradation in the positioning accuracy can be prevented.

Next, a second exemplary embodiment is described.

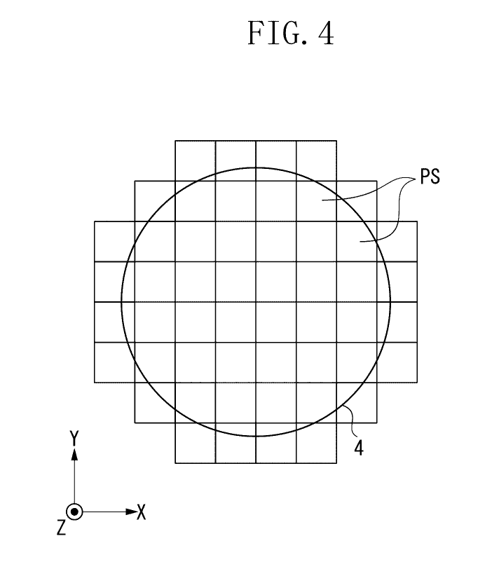

FIG. 4 is a diagram illustrating an example of imprint positions (shot area) for the substrate 4. An area surrounded with a rectangle represents an imprint position. Areas including the outer circumference (edge) of the substrate 4 among the imprint positions illustrated with the rectangles are also referred to as peripheral shots PS. A part of the pattern 2b formed on the mold 2 is transferred onto the peripheral shots PS.

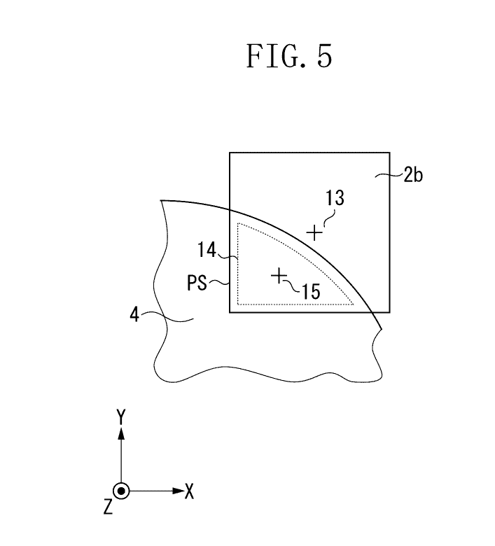

FIG. 5 is a diagram illustrating the positional relationship between the mold 2 and the substrate 4 when a pattern is formed on the peripheral shot PS. FIG. 5 illustrates the mold and the substrate 4 viewed in a direction (Z direction) perpendicular to the surface of the substrate 4 (mold 2).

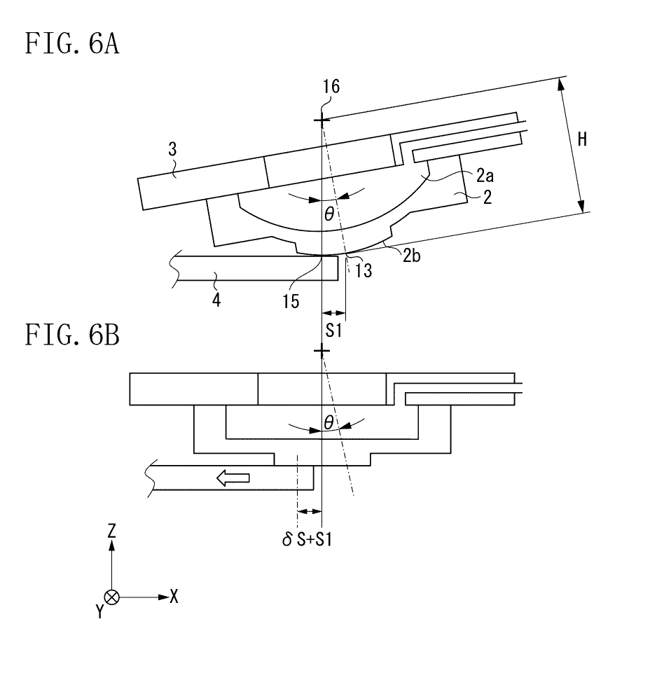

FIGS. 6A and 6B are each a side view (viewed in, e.g., the Y direction) illustrating the state of the mold 2 and the substrate 4 when the pattern is formed in the peripheral shot PS.

The second exemplary embodiment is described focusing on how the pattern is formed in the peripheral shot PS illustrated in FIG. 4 (in the imprint processing). Matters not referred to in the second exemplary embodiment are similar to those in the first exemplary embodiment.

As illustrated in FIG. 5, in a case where the pattern is formed on the peripheral shot PS at the peripheral portion including the outer circumference of the substrate 4, the pattern 2b of the mold 2 only partially overlap with the substrate 4. Accordingly, a center 13 of the pattern 2b of the mold 2 deviates from a centroid 15 of a pattern formation area 14 (an area of the peripheral shot PS) where the pattern is to be formed on the substrate 4. In a case where the pattern is formed at any part of the imprint positions (referred to as a center shot herein) illustrated in FIG. 4 other than the peripheral shots PS, the center 13 of the pattern 2b does not deviate from the centroid 15 of the pattern formation area 14. In a case where the pattern is formed in a manner similar to the case where the pattern is formed on the center shot, with the center 13 of the pattern 2b deviating from the centroid 15 of the pattern formation area 14, the mold 2 may come into contact with the outer circumference of the substrate 4. Furthermore, deviation of the center 13 of the pattern 2b from the centroid 15 of the pattern formation area 14 may increase time to fill the pattern 2b with the imprint material. Furthermore, it is desirable that the mold 2 is brought into contact with the imprint material on the pattern formation area 14 in such a manner that the mold 2 first comes into contact with the centroid 15 and then the contact area gradually increases toward the periphery. This configuration can prevent the contact of the mold 2 with the outer circumference of the substrate 4, and reduce the time to fill the pattern 2b with the imprint material.

To that end, in the case of forming the pattern on the peripheral shot PS, the imprint processing starts in a state that the surface of the mold 2 on which the pattern 2b is formed is inclined with respect to the surface of the substrate 4 as illustrated in FIGS. 6A and 6B. An inclined angle θ of the mold 2 with respect to the substrate 4 is adjusted based on the positional relationship (offset amount) between the center 13 of the pattern 2b of the mold 2 and the centroid 15 of the pattern formation area 14 on the XY plane. In FIGS. 6A and 6B, the inclined angle θ is an angle between a direction perpendicular to the pattern 2b of the mold 2 and the Z direction. With the inclined angle θ thus adjusted based on the pattern 2b and the pattern formation area 14, the contact start position between the pattern 2b and the imprint material on the peripheral shot PS can be at the centroid 15 of the pattern formation area 14.

The mold 2 may be inclined with at least three mold driving mechanisms 7 driven in the Z direction each of which has mutually different movement amount. Alternatively, a driving mechanism for inclining the mold 2 may be provided separately from the mold driving mechanism 7. Furthermore, since relative inclining between the mold 2 and the substrate 4 is required, the substrate 4 or both the mold 2 and the substrate 4 may be inclined.

In the imprint processing, the mold 2 that has been inclined as illustrated in FIG. 6A is returned to the horizontal position (XY plane) by driving the mold driving mechanism 7 or a driving mechanism for inclining a mold separately provided after the pattern 2b has contacted the imprint material on the substrate 4.

The driving force (or shearing force) generated on the substrate stage 6 with respect to the XY plane is measured in the imprint processing, as in the first exemplary embodiment. The driving force (or shearing force), with respect to the XY plane, generated on the substrate stage 6 is measured in the imprint processing in the period starting when the pattern 2b of the mold 2 comes into contact with the imprint material on the substrate 4 and ending when the pattern 2b is separated from the imprint material that has been cured. In the second exemplary embodiment, the driving force generated on the substrate stage 6 with respect to the XY plane is measured while the mold 2 that has inclined returns to an attitude corresponding to the XY plane. The control unit 10 calculates speed and position realizing small driving force with respect to the XY plane based on a value of the measured driving force of the substrate stage 6.

Here, the substrate stage 6 may be offset in advance by the movement amount δS for achieving small driving force obtained in advance, before the pattern 2b of the mold 2 comes into contact with the imprint material on the substrate 4. In this manner, the positioning between the mold 2 and the substrate 4 with the substrate stage 6 can be facilitated even in a case where the mold 2 that has been inclined is moved to return to the original position after the pattern 2b and the imprint material have contacted each other.

In the second exemplary embodiment, the mold 2 is inclined about a rotation center 16 not on the pattern 2b. Accordingly, the position of the pattern 2b on the XY plane is shifted by an amount S1 at the time point where the pattern 2b starts contacting the imprint material on the substrate 4. Thus, the positions of the mold 2 and the substrate 4 on the XY plane need to be offset from each other by the amount S1 before the imprint processing starts. In other words, the substrate stage 6 is offset by an amount δS+S1 in advance before the pattern 2b comes into contact with the imprint material on the substrate 4. The amount S1 can be calculated by using the inclined angle θ and a distance between the rotation center 16 for the inclining of the mold 2 and the center 13 of the pattern 2b.

As in the first exemplary embodiment, the movement amount 5s of the substrate stage 6 obtained in advance may be determined based on a material of the adhesion layer supplied between the substrate 4 and the imprint material, a material of the mold 2, and a layout of the pattern formed on the mold 2. The movement amount δS of the substrate stage 6 may also be determined based on the viscosity, the supplied amount, the coating pattern, and the like of the imprint material. In such a manner, the movement amount δS of the substrate stage 6 may be obtained based on aspects that might affect the driving force required for changing the relative position of the mold 2 and the substrate 4.

### (Manufacturing Method for Item)

A method for manufacturing a device (such as a semiconductor integrated circuit element or a liquid crystal display element) as a product includes forming a pattern on a substrate (a substrate in a form of a wafer, a glass plate, or a film) by using the imprint apparatus described above. The manufacturing method may further include etching the substrate on which the pattern has been formed. In a case where a different type of product such as a patterned medium (recording medium) or an optical element is to be manufactured, the manufacturing method may include another process of processing the substrate on which the pattern has been formed, instead of the etching. The manufacturing method for a product according to the present exemplary embodiment is advantageous over conventional methods in at least one of performance, quality, productivity, and manufacturing cost of the product.

The exemplary embodiments of the present disclosure are described above. The disclosure is not limited to the exemplary embodiments.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-237870, filed Dec. 4, 2015, which is hereby incorporated by reference herein in its entirety.

What is claimed is:

1. An imprint apparatus configured to form a pattern of an imprint material on a substrate with a mold, the imprint apparatus comprising:
a mold holding unit configured to hold the mold;
a substrate holding unit configured to hold the substrate;
a driving mechanism configured to change a relative position of the mold holding unit and the substrate holding unit; and
a control unit configured to control, when the relative position of the mold holding unit and the substrate holding unit is changed while the mold is in contact with the imprint material on the substrate, the driving mechanism in such a manner that driving force to be generated due to viscoelasticity of the imprint material becomes smaller.

2. The imprint apparatus according to claim 1, wherein the control unit is configured to change the relative position of the mold holding unit and the substrate holding unit in a plane direction of the substrate while the mold is in contact with the imprint material.

3. The imprint apparatus according to claim 2, wherein, in a case where the driving mechanism is to change the relative position of the mold holding unit and the substrate holding unit in a direction by a movement amount, the control unit is configured to change the relative position of the mold holding unit and the substrate holding unit before the mold comes into contact with the imprint material in a direction opposite to the direction in which the relative position is to be changed by the movement amount.

4. The imprint apparatus according to claim 3, wherein the movement amount is determined based on at least one of a material of an adhesion layer to be supplied between the substrate and the imprint material, a material of the mold, a layout of the pattern formed on the mold, viscosity of the imprint material, a supplied amount of the imprint material, and a coating pattern of the imprint material.

5. The imprint apparatus according to claim 1, further comprising a mold deforming mechanism configured to deform the mold in a protruding shape toward the substrate,
wherein the driving mechanism is configured to incline a surface of the mold on which the pattern is formed relative to the surface of the substrate in a state where the mold has been deformed by the mold deforming mechanism, and
wherein the control unit is configured to bring the mold in contact with the imprint material in a state where the surface of the mold on which the pattern is formed is inclined relative to the surface of the substrate.

6. The imprint apparatus according to claim 5, wherein the driving mechanism is configured to incline, in a case where a part of the pattern formed on the mold is transferred onto the substrate, the surface of the mold on which the pattern is formed relative to the surface of the substrate, in such a manner that the mold comes into contact with the imprint material on the substrate in an area on the substrate where the pattern is to be formed.

7. A manufacturing method of forming a pattern of an imprint material on a substrate with an imprint apparatus, the imprint apparatus including a mold holding unit configured to hold the mold, a substrate holding unit configured to hold the substrate, and a driving mechanism configured to change a relative position of the mold holding unit and the substrate holding unit, the manufacturing method comprising:
controlling, when the relative position of the mold holding unit and the substrate holding unit is changed while the mold is in contact with the imprint material on the substrate, the driving mechanism in such a manner that driving force to be generated due to viscoelasticity of the imprint material becomes smaller; and
processing the substrate on which the pattern has been formed in the forming.

8. An imprint method for forming a pattern on an imprint material on a substrate with a mold, the imprint method comprising:
bringing the mold into contact with the imprint material on the substrate; and
positioning the mold and the substrate by changing relative position of a mold holding unit configured to hold the mold and a substrate holding unit configured to hold the substrate in such a manner that driving force generated due to viscoelasticity of the imprint material becomes smaller when the relative position of the mold holding unit and the substrate holding unit is changed while the mold and the imprint material on the substrate are in contact with each other.

9. The imprint method according to claim 8, wherein, in the bringing of the mold into contact with the imprint material on the substrate, the mold is brought into contact with the imprint material with a surface of the mold on which the pattern is formed inclined relative to a surface of the substrate in a state where the mold is deformed to protrude toward the substrate.
